(19) United States
(12) Patent Application Publication
(10) Pub. No.: US 2004/0102323 A1
(43) Pub. Date: May 27, 2004

(54) Solid herbicidal formulation of N-(phosphono-methyl)glycine and process for its preparation

(76) Inventors: Jorge Gustavo Vigil, Buenos Aires (AR); Martha Maria Del Carmen Ruiz, Buenos Aires (AR); Dante Omar Anacabe, Talar De Pacheco (AR)

Correspondence Address: JACOBSON HOLMAN PLLC, 400 SEVENTH STREET N.W., SUITE 600, WASHINGTON, DC, 20004, US

(21) Appl. No.: 10/714,870

(22) Filed: Nov. 18, 2003

(30) Foreign Application Priority Data
Nov. 19, 2002 (AR) P 02 01 04441

(51) Int. Cl. A01N 57/18; A01N 25/12

(52) U.S. Cl. 504/206; 504/367

(57) ABSTRACT

A solid herbicidal formulation of N-(phosphonometyl)glycine is described, in powder, granule, or flake form, soluble or dispersible in water, is described, containing Glyphosate (N-(phosphonomethyl)glycine) in the form of hydrosoluble salt and also including 5% to 30% in weiglit of one or more tensioactive agents, soluble in water, compatible with glyphosate and which are solid at ambient temperature, i.e. at approximately 25° C. The process for preparation of said herbicidal formulation is also described.

### BACKGROUND OF THE INVENTION

1. Field of the Invention

The present invention generally relates to a solid herbicidal formulation of Glyphosate (N-(phosphonomethyl)glycine) and the process for the preparation of the formulation.

2. Description of the Prior Art

Glyphosate (N-(phosphonomethyl)glycine) is an organic acid, not very soluble in water (12 g/L), with efficient herbicide activity.

Said compound is generally formulated as a concentrated solution of the soluble monoisopropyl ammonium salt in water. However, it may also be formulated as an ammonium, sodium, or potassium salt.

Literature contains references to many patents describing the preparation methods of said formulations and the results obtained with them in weed control (see, as an example, U.S. Pat. Nos. 3,799,758 and 4,405,531 granted on Mar. 26, 1974 and Sep. 20, 1983, respectively).

Glyphosate may also be prepared as a solid herbicidal formulation (in powder, granules, or flakes), which is currently the preferred preparation form of this herbicide because said solid form has numerous advantages compared to the liquid formulation, such as cost savings in containers, the fact that the product is very easy to store, and transport, plus the possibility of preparing the herbicidal formulations with greater concentrations of the active principle.

Said solid formulations have been described, for example, in the Japanese patents JP 62175408 and JP 62175408 [sic] and in European patents EP 0 255 760, EP 0 204 146, and EP 0 206 537.

In turn, U.S. Pat. Nos. 5,872,078 and 6,228,807 refer to the formulation of Glyphosate granules using surfactants or tensioactive agents which are liquid at 25° C.

In addition, U.S. Pat. Nos. 5,612,285 and 5,693,593 describe the same formulations containing liquid surfactant at 25° C. but with the addition of an extrusion agent (a polyalkylene glycol, in which the alkylene oxide is ethylene, propylene, or butylene oxide, and said polyalkylene glycol has a MW ranging between 1,000 and 15,000). In addition U.S. Pat. No. 5,750,469 mentions the use of ether amines as humectants for Glyphosate granules.

Lastly, U.S. Pat. No. 6,051,533 uses an ethoxylated alkylamine and a silicon block copolymer as surfactant.

The background examples above are representative of the preparation of solid herbicidal formulations by wet techniques.

One of these methods includes mixing the ingredients with water and then spraying and drying the suspension to obtain the product in powder or granule form.

Another method to prepare said granulated formulations includes mixing the ingredients with water, drying the mass in a roller drum for flakes and subsequently grinding the flakes until the granular composition is obtained.

Another method to prepare granulated formulations includes mixing Glyphosate and the base, for example ammonium bicarbonate, adding water, cystallizing, centrifuging, mixing with surfactant, and drying the granulated product.

Finally, another known method to prepare a granular formulation is to make the ingredients react in a drying fluidized bed using a wet cake of Glyphosate, or wet Glyphosate containing a minimum of moisture to allow for the neutralization phase of the process, and then complete the drying to obtain the granulated product.

However, all these wet techniques present difficulties and disadvantages which may be summarized as follows:

Use of costly equipment,

High energy expense,

Technical difficulties in handling wet Glyphosate,

Multiple operating stages to reach the final product,

### SUMMARY OF THE INVENTION

The Applicant has proposed to solve the difficulties and disadvantages of the prior art by proposing a new process to prepare a novel dry, solid herbicidal formulation, in powder, granule, or flake form, soluble or dispersible in water, containing Glyphosate in the form of one of its hydrosoluble salts and including, in addition, one or more tensioactive agents which are solid at ambient temperature. i.e. at around 25° C.

The invention refers, first of all, to a dry, solid herbicidal formulation, in powder, granule, or flake form, containing a hydrosoluble salt of Glyphosate (N-(phosphonomethyl)glycine), and also containing 5% to 30% in weight of one or more Glyphosate-compatible, hydrosoluble tensioactive agents, which arm solid at ambient temperature, i.e. at approximately 25° C.

The invention also refers to a dry method of preparing said formulations.

The process to prepare the solid herbicidal formulations of this invention includes, essentially, the following stages:

a) Glyphosate+basic neutralization agent→hydrosoluble Glyphosate salt,

b) Glyphosate salt+solid humectant agent→powder, granules, or flakes,

whereby it is possible to carry out both stages successively or simultaneously.

The use of one or more tensioactive agents which are solid at 25° C. during the preparation process of the final product offers the following advantages:

a) When the solid tensioactive agent is mixed with Glyphosate and the neutralization agent, a homogeneous product is quickly and easily obtained with resulting energy savings;

b) The tensioactive agent may be added during the neutralization stage so that the process may be carried out in one stage; and

c) The tensioactive agent may act as extrusion agent if the final mixture is to be processed in an extruder.

Glyphosate may be neutralized with gaseous ammonia, ammonium, potassium, or sodium hydroxide; ammonium, potassium or sodium bicarbonates, carbonates, or sulfates.

In addition, during the preparation process it is possible, as an option, to add to the mixture a synergic agent, a co-herbicide, a colorant, a corrosion inhibitor, a thickening agent, a dispersant, a sequestering agent of calcium and magnesium ions, and an anti-foaming agent.

Tensioactive agents which are solid at 25° C. are selected among those compounds pertaining to the following chemical families:

Alkanolamides

Alkyl aryl sulfonates

Sulfonated amines and amides

Ethoxylated alkylphenols

Carboxylated alcohols

Ethoxylated fatty acids

Ethoxylated alcohols

Sulfated alcohols

Sugar and Glucose Derivatives

Sorbitol Derivatives

Phosphate esters

Imidazoline and its derivatives

Lecitin and its derivatives

Lignin and its derivatives

Polymer block (ethylene and propylene oxide)

Ethoxylated alcohol sulfates

Fatty acid sulfates

Naphthalene and alkyl naphthalene sulfonates

Dodecyl and tridecylbenzene sulfonates

Taurates and their derivatives

### DESCRIPTION OF THE PREFERRED EMBODIMENT

### 1—Preparation of the Hydrosoluble Salt

Glyphosate and the base, preferably ammonium bicarbonate, are loaded into a kneader, mixer (or similar). The addition is done slowly at ambient temperature, kneading or mixing the ingredients.

The final point can be determined by calculating the release of carbon dioxide and establishing the pH of the final product, which must be between 3.9 and 4.2.

During neutralization, the mixture is moistened up to between 5 and 10% in weight, due to the water released during neutralization.

### 2—Addition of the Tensioactive Agent(s)

The solid tensioactive agent(s) at 25° C. are added, mixing them with the hydrosoluble salt of Glyphosate for the time needed to obtain a homogeneous mixture.

By working with solid tensioactive agents, the neutralization stages and the addition of the humectant may be done simultaneously.

### 3—Granulation

Granulation may be done by extrusion or cake system (rotating plates).

During granulation, it is observed that it is helped by using one or more solid tensioactive agents because an easy-to-handle mass is obtained, unlike the product obtained with a liquid humectant, which produces a sticky mass that is hard to work with or handle.

### 4—Drying

The granules obtained, which contain approximately between 5 and 10% moisture in, weight may be dried in a static bed dryer, in a conveyor pan, or belt or in a dynamic dryer (fluidized bed) up to moisture values of ≦0.5% in weight

The mixture may also be dried after the addition of the tensioative agents, grinding the dry mixture to obtain a soluble powder.

### PREPARATION EXAMPLES

### Example 1

The following are loaded i a circular kneader with two rotating rolls:

Glyphosate acid (titer: 92.6%, wet base) . . . =574 g

Ammonium bicarbonate . . . =250 g

Atplus UCL 1007 (Uniquema) . . . 194 g

(Urea-supported ethoxylated alcohol)

Glyphosate and bicarbonate are added alternately for 15 minutes at ambient temperature.

When the addition is finished, the mixture continues being stirred for another 30 minutes to ensure complete neutralization.

Then the ATPLUS UCL 1007 solid tensioactive agent is added and the mixture is kneaded for 10 minutes.

The mass obtained is extruded in a medium pressure screw extruder with perforated plates interchangeable for the diameter of grains required, with output regulated by changing the speed of the feeder screw. The granules obtained are dried on a conveyor belt at 50° C. up to a moisture content of ≦0.5% in weight.

### Example 2

The following are loaded into a kneader:

Glyphosate (titer: 92.6%, wet base) . . . =1,148 g

Ammonium bicarbonate . . . =498 g

MYRS 49P (Uniquema) . . . =388 g

(fatty acid polyoxyethylene ester)

The neutralization is carried out simultaneously with the addition of the tensioactive agent, monitoring the reaction by the release of carbon dioxide with an Abiss CM 12P carbon dioxide analyzer.

The mass obtained is flaked and dried in an oven at 50° C. up to a moisture value of ≦0.5% in weight.

### Example 3

The following are loaded alternately in a 2 L balloon flask equipped with mechanical stirring:

Glyphosate (titer: 90.6%, wet base) . . . =293 g

Ammonium bicarbonate . . . =125g

Gerpon SDS (Rhodia) . . . =97 g

(sodium dioctylsulfosuccinate)

After completing the neutralization, the mixture is extruded and dried in an oven at 50° C. up to a moisture content of ≦0.5% in weight.

### Example 4

Carried out under the same conditions as example 1 but using Geropon T-77 (sodium methyl oleyltaurate) from Rbodia as humectant.

### APPLICATION EXAMPLES (IN THE FIELD)

After evaluating the herbicidal activity of the formulations according to the invention, tests were conducted in a field in the La Pampa province (Argentina) in soil with the following characteristics:

Predecessor: sunflower stubble.

Cultivation: conventional sowing.

Soil data: O.M. (organic material)=1.64% in weight; pH=6.37.

Ambient temperature: 2.7° C.,

Relative humidity: 83%

Application method of the herbicide: by hand, “flodd [sic] jet” nozzle, 100 liters/hectare.

The experiment was conducted in random blocks with 3 repetitions. Weeds present: hanging thistle (Cardus nutans), wild celery (Ammi majus), mustard seed (Hirschfeldia incana), yellow star thistle (Centáurea solstitialis), lamium (Lamium amplexicaule), and curled dock (Rumex sp).

Chemical analysis of the water used in the tests:

pH . . . 8.80

Carbonates . . . 150.70 ppm

Bicarbonates . . . 316.20 ppm

Sodium bicarbonates . . . 435.40 ppm

Calciun . . . 2.00 ppm

Magnesium . . . 1.68 ppm

Sodium . . . 402.50 ppm

Hardness (as CaCO3) . . . 12.00 ppm

The herbicidal efficacy of three granulated formulations of glyphosate, named A, B, and C, with the following composition, was analyzed;

Granulate A: (Mono)ammonium glyphosate 74.7%. Liquid tensioactive (at 25° C.): 25.3%.

This formulation A corresponds to a formulation of the previous art used for comparison.

### Formulations According to the Invention

Granulate B: (Mono)ammonium glyphosate 75%, ATPLUS UCL 1007 25% (solid tensioactive at 25° C.).

Granulate C: (Mono)ammonium glyphosate 79.5% GERAPON T 77 20.5% (solid tensioactive at 25° C.).

Herbicidal efficacy results of 20 days on the aforementioned weeds are indicated in Table 1 below, where doses are expressed in Kg of herbicide/hectare and the Control Average corresponds to the average percentage (%) of damage to the weeds.

TABLE 1

| % | | | | | | | |
|---|---|---|---|---|---|---|---|
| Formu- | | | Mustard | | Star | | Control |
| lation | D se | Thistle | Seed | Lamium | Thistle | Celery | Average |
| Granu- | 1.0 | 50 | 50 | 50 | 60 | 50 | 52 |
| late A | 1.5 | 60 | 60 | 60 | 60 | 60 | 60 |
| | 2.0 | 60 | 60 | 60 | 60 | 60 | 60 |
| Granu- | 1.0 | 70 | 70 | 70 | 70 | 70 | 70 |
| late B | 1.5 | 75 | 80 | 70 | 80 | 80 | 77 |
| | 2.0 | 75 | 80 | 70 | 80 | 80 | 77 |
| Granu- | 1.0 | 60 | 60 | 60 | 60 | 60 | 60 |
| late C | 1.5 | 75 | 70 | 70 | 75 | 70 | 72 |
| | 2.0 | 75 | 75 | 80 | 80 | 80 | 78 |

After 60 days, the results obtained as indicated in Table 2 below.

TABLE 2

| % | | | | | | | |
|---|---|---|---|---|---|---|---|
| Formu- | | | Mustard | | Star | | Control |
| lation | Dose | Thistle | Seed | Lamium | Thistle | Celery | Average |
| Granu- | 1.0 | 100 | 90 | 100 | 100 | 97.5 | 97.5 |
| late A | 1.5 | 100 | 97.5 | 100 | 100 | 100 | 99.5 |
| | 2.0 | 100 | 97.5 | 100 | 100 | 100 | 99.5 |
| Granu- | 1.0 | 100 | 97.5 | 100 | 100 | 100 | 99.5 |
| late B | 1.5 | 100 | 100 | 100 | 100 | 100 | 100 |
| | 2.0 | 100 | 100 | 100 | 100 | 100 | 100 |
| Granu- | 1.0 | 100 | 97.5 | 100 | 100 | 100 | 99.5 |
| late C | 1.5 | 100 | 97.5 | 100 | 100 | 100 | 99.5 |
| | 2.0 | 100 | 100 | 100 | 100 | 100 | 100 |

### Analysis of the Results

In general, in the evaluations after 20 days, the best formulas were granulates B and C in the doses of 1.5 to 2 Kg/ha of herbicide applied.

In the evaluations after 60 days, mustard seed showed the highest tolerance to the herbicide, while formulations B and C showed, in general, better herbicidal efficacy than formulation A.

### Conclusion Based on Field Results

As can be observed, the use of a solid tensioactive agent in the manufacture of Glyphosate granules as monoammonium salt, did not show any inconvenience concerning their dissolution in the water used in the field during the tests.

On the other hand, the granules obtained with said tensioactive agents presented an herbicidal activity similar or greater than those manufactured with liquid tensioactive agents, which also indicates that said tensioactive agents have humectant action on the herbicide's capacity to be absorbed by the plants, similar or greater than Glyphosate herbicides formulated with liquid tensioactive agents.

What is claimed is:

1. A solid herbicidal formulation of N-(phosphonomethyl)glycine, in powder, rule or flake form, soluble or dispersible in water, comprising Glyphosate (N-(phosphonomethyl)glycine) in the form of hydrosoluble salt and 5% to 30% in weight of one or more hydrosoluble tensioactive agents, which are compatible with Glyphosate and solids at ambient temperature, preferably at about 25° C.

2. The formulation in accordance with claim 1, wherein the solid tensioactive agent or agents at 25° C. is/are selected from the following chemical families:
Alkanolamides
Alkyl aryl sulfonates
Sulfonated amines and amides
Ethoxylated alkylphenols
Carboxylated alcohols
Ethoxylated fatty acids
Ethoxylated alcohols
Sulfated alcohols
Sugar and Glucose Derivatives
Sorbitol Derivatives
Phosphate esters
Imidazoline and its derivatives
Lecithin and its derivatives
Lignin and its derivatives
Polymer block (ethylene and propylene oxide)
Ethoxylated alcohol sulfates
Fatty acid sulfates
Naphthalene and alkyl naphthalene sulfonates
Dodecyl and tridecylbenzene sulfonates
Taurates and their derivatives

3. The formulation in accordance with claim 1, wherein the formulation contains the ammonium, sodium, or potassium salt of Glyphosate.

4. The formulation in accordance with claim 1, wherein the formulation contains between 5% and 30% in weight of the humectant.

5. The formulation in accordauoe with claim 1, wherein the melting point of the tensioactive agents is higher than 30° C.

6. A process for the preparation of the herbicidal formulations in accordance with claim 1, comprising the steps of:
(a) mixing N-(phosphonomethyl)glycine with an equimolar quantity of the neutralization base and between 5% and 30% in weight of the solid tensioactive agent of the dry weight of the final mixture, at 25° C.
(b) kneading or mixing the resulting formulation until the mixture is completely homogenized, and
(c) processing the resulting mixture until obtaining the desired formulation, in powder, granules, or flakes.

7. The process in accordance with claim 6, wherein the step (c) further includes the steps of:
extruding the homogeneous mixture and drying the resulting pellets up to a moisture content of ≦0.5% in weight.

8. The process in accordance with claim 6, wherein the step (c) further includes the steps of:
drying the homogeneous mixture up to a moisture content of ≦0.5% in weight and grinding the resulting product up to the desired granulometry.

9. The process in accordance with claim 6, wherein the step (c) further includes the steps of:
ganulating the homogeneous mixture up to the desired distribution of sizes and drying the granules obtained up to a moisture content of ≦0.5% in weight.
